(19) United States
(12) Patent Application Publication
(10) Pub. No.: US 2006/0291333 A1
(43) Pub. Date: Dec. 28, 2006

(54) Real time earth clock

(76) Inventor: Richard Kostura, Huntington, NY (US)

Correspondence Address: Mr. Richard Kostura, 109 High Street, Huntington, NY, 11743, US

(21) Appl. No.: 11/142,536

(22) Filed: May 31, 2005

(51) Int. Cl. G04B 49/00

(52) U.S. Cl. 368/15

(57) ABSTRACT

A unique conceptual design of perceiving or expressing time through a more comprehensive time mode, indicating time not by a usual 12 hour schedule but through a 24 hour 365 day format whereby the representation of such time is reflective by scientific duration of a tangible time table of the earths revolution around the sun and or reflective by its reverse quartz display of numerical time and can be furthermore mirrored/sequenced by a complete time progression of a particular day while concomitantly accurately indicating the seasons by the earth movement along its axis, thereby transform time in a more scientific approach. The systematic method to time telling is a unlike any time indicating mechanism but adopts a more proactive & precise apparatus in having a scientific display through terrestrial appurtenances. It can further added that the time table of the earth's revolution around the sun can be of an actual physical representation of a two or three dimensional showing within the window display of the device. Furthermore, it's mirrored/sequence of time can be of a replica earth dial assimilating to corresponding time to geographical locations by generalization or actual time by movement of the earth's effigy encased in the earth dial.

### FIELD OF INVENTION

The product's field of invention relates to time dissemination but reforming time perception and understanding in a more revolutionary approach by having dissimilar mechanisms found in traditional time exploration or mechanics but keeping within the scope of scientific or atomic anatomy of time tracking

### BACKGROUND—DESCRIPTION OF PRIOR ART

### DESCRIPTION OF PRIOR/RELATIVE ART

Many propositions have been promulgated about the evolution of the depiction and expression of time. Many inventors have come forth with creative expressions of time telling devices showing appurtenances contained within the base frame of a clock, adorning our senses with realism of our interplanetary system or system of displaying twenty-four hour formats manifested through earth dials of a celestial format equating time to its relative sense. While each creative artist has its own expression on how such should be expressed, our present invention shows time by use of applied sciences in the form of time expressed in an atomic fashion, depicting real time in the true scientific equations.

Relative to the design aspects, inventions such as U.S. Pat. No. 4,583,864 creates similar notions of interplanetary appurtenances but lack the realism of the sun and the relation of the earth in an axial rotation with the sun. Time here is expressed in a clock ward fashion, representative of a 12 hour day format. While the earth has axial rotation, it dissolves itself from true revolution depiction and/or time representation of day and yearly time as it relates to the earths rotation around the sun. Realism is another lacking element with daylight and nightlight casting which the present invention has also overcome and the true likeness of the sun as a planet. The invention disclosed also does not show or indicate axial changes indicative of the seasons.

Relative to the design aspects, invention U.S. Pat. No. 4,142,306 is constructed and representative of a dial mechanical device showing plane non dimensional depictions of orbital planets. Time expression is expressed in a counterclockwise 12 hour format. The invention lacks the atomic expression of time and the axial movement that the earth has in a true relation to the sun. The invention does not overcome the interplanetary correlations that the celestial planets have with one another except stationary appurtenances that are less dimensional in the true sense.

Relative to the design aspects, U.S. Pat. No. 584,851 is a tellurian representation of a dial time device inclusive of the relations in its orbit surroundings, correlating the axial and revolutions of the earth to the sun. The globe itself by it sheer revolution of its axis is told to represent time but there lacks the simulation of numerical time table either in the 12 hour format or as what my invention shows as the 24 hour format. The purported aspects supposedly manifests without any real depiction, the day and night sequence of time but only expressed through the common knowledge of the earths revolution. While the device itself has capabilities to have axial changes for the illustration of seasonal changes, the practicality still has not meet with personification of celestial realism. This invention is more classified as a dial clock having less true interrelated inter-terrestrial relations but more of an allegory of what it should be.

Relative to the design aspect, invention U.S. Pat. No. 246,061 is a unique time depiction device diligently having concomitant methods of expressing the earth's revolution, summer and winter solstice, days of the week and time in the 12 hour format but lacks the sense of interplanetary relation in its spherical dimension. Time is expressed as 12 hour formats not as the true dimensional sense of the earths and sun inter-relational movement(s). The earth revolves in a plane rotational movement around a numerical display depicting earth in the 12 hour format but not in the true revolution around the sun itself. The day of the week although mechanically driven in sequence to the earth's plane revolution, has no bearing on the true essence of atomic exploration of time telling in the sequence between the earths movement and expression to it in hours and/or days, nor does it combine the essential elements of the earth to the sun rotational relationship.

Relative to the design aspect, invention U.S. Pat. No. 4,671,669 is another prime example of an ordinary clock ward expression of time with the inclusion of placing some planetary objects within the background of the clock's display. Although the earth as shown by others rotates on its axis to show the revolution, the clock does not display the planetary expression of time in relation to its movements in a sequential manner to one another, particularly the earth to the sun. It basically is inclusive of a stationary opaque sun centered in the middle of the display with an earth object circulating in the normal traditional fashion of time. There is no representation of the earth true revolution and axial movement in relation to one complete revolution of the earth to equal one day except by visual observation and cognizant of earths inter-relationship and its expression of time. The summer and winter solstice and other planetary wonders are eschewed.

Therefore it is appropriate to observe from the following that the present invention clearly overcomes the obstacles of clearly depicting, representing and displaying the true planetary features and dimensions of the sun and earth at the same time atomically expressing time in the counterclockwise 24 hour format by concomitantly having the depiction of the N-S axial movement and changes of the earth to the sun along with expressive nuances of the time of day.

Other patents disseminated herein correlate to the movement relating to the utility aspects of the Real Time Earth Clock

U.S. Pat. No. 5,917,778 is indicative of an earth clock less tenable than its counter part expressed within this provisional patent in regards to relative expression of time in its appearance of celestial depictions. Although the current patent implies an adaptation to show time in geographical simultaneous areas, it lacks the fundamental design of the dial format indicating or showing time in the format discussed herein this application.

U.S. Pat. No. 5,197,043 is another quintessential manifestation of an effective design apparatus lacking to show time in the 24 dial format as it equates to celestial time and its relation thereof. The clock shows a model of the earth in a two dimensional view encased in its base frame with time depicted in the usual 12 hour format. The earth replica and its design aspects conjectures accurate depiction of time simultaneous to paralleling to a geographical area to express time to that sphere on the earth's surface. Although there can be many untenable facets made to these claims they do not relate to the identical design aspects of our provisional.

Other inventions such as U.S. Pat. No. 4,583,864 creates similar notions of interplanetary appurtenances but lack the realism of the sun and the relation of the earth with the sun in a axial rotation. Time here is expressed in a clock ward fashion, representative of a 12 hour day format. While the earth has axial rotation, it dissolves itself from true revolution depiction and/or time representation of day and yearly time as N relates to the earths rotation around the sun. Realism is another locking element with daylight and nightlight casting which the present invention has also overcome and the true likeness of the sun as a planet. The invention disclosed also does not show axial changes indicative of the seasons.

Invention U.S. Pat. No. 4,142,306 is constructed and representative of a dial mechanical device showing plane non dimensional depictions of orbital planets. Time expression is expressed in a counterclockwise 12 hour format. The invention lacks the atomic expression of time and the axial movement that the earth has in a true relation to the Sun. The invention does not overcome the interplanetary correlations that the celestial planets have with one another except stationary appurtenances that are less dimensional in the true sense.

The patent U.S. Pat. No. 584,851 is a tellurian representation of a dial time device inclusive of the relations in its orbit surroundings, correlating the axial and revolutions of the earth to the Sun. The globe itself by it sheer revolution of its axis is told to represent time but there lacks the simulation of numerical time table either in the 12 hour format or as what my invention shows as the 24 hour format. The purported aspects supposedly manifests without any real depiction, the day and night sequence of time but only expressed through the common knowledge of the earths revolution. While the device itself has capabilities to have axial changes for the illustration of seasonal changes, the practicality still has not meet with personification of celestial realism. This invention is more classified as a dial clock having less true interrelated inter-terrestrial relations but more of an allegory of what it should be.

Invention U.S. Pat. No. 246,061 is a unique time depiction device diligently having concomitant methods of expressing the earth's revolution, summer and winter solstice, days of the week and time in the 12 hour format but lacks the sense of interplanetary relation in its spherical dimension. Time is expressed as 12 hour formats not as the true dimensional sense of the earths and sun inter-relational movement(s). The earth revolves in a plane rotational movement around a numerical display depicting earth in the 12 hour format but not in the true revolution around the sun itself. The day of the week although mechanically driven in sequence to the earth's plane revolution, has no bearing on the true essence of atomic exploration of time telling in the sequence between the earths movement and expression to it in hours and/or days, nor does it combine the essential elements of the earth to the sun rotational relationship.

Invention U.S. Pat. No. 4,671,669 is another prime example of an ordinary clock ward expression of time with the inclusion of placing some planetary objects within the background of the clock's display. Although the Earth as shown by others rotates on its axis to show the revolution, the clock does not display the planetary expression of time in relation to its movements in a sequential manner to one another, particularly the Earth to the Sun. It basically is inclusive of a stationary opaque Sun centered in the middle of the display with an Eearth object circulating in the normal traditional fashion of time. There is no representation of the Earth true revolution and axial movement in relation to on complete revolution of the Earth to equal one day except by visual observation and cognizant of earths inter-relationship and its expression of time. The summer and winter solstice and other planetary wonders are eschewed.

Therefore it is appropriate to observe from the following that the present invention clearly overcomes the obstacles of clearly depicting, representing and displaying the true planetary features and dimensions of the sun and earth at the same time atomically expressing time in the counterclockwise 24 hour format by concomitantly having an earth dial which may remain stationary or may have the objective simulation to maneuver as it related to its time sequence and correlation to geographical depiction or having the depiction of the N-S axial movement and changes of the earth to the sun along with expression the nuances of time of day.

### OBJECTS AND ADVANTAGES

Accordingly, there are many objectives and advantages of my invention which are present in the design and function of the Real Time Earth Clock. The palpable display of depicting time in the truest fashion by way of celestial interaction of the Earth's coexistence with the Sun and the corresponding relationship of such resulting in daylight and night time display. These appurtenances can be represented in either a two or three dimensional view. In addition to the realism shown, the Real Time Earth not only is a fascinating display of movement but can provide a teachable sustenance to children on how time is in relation to the planetary interaction hence showing time in an atomic fashion. The atomic method of display provides time movement through the 24 hour formatted face of the base frame while simultaneously having the rotation of the Earth with the clock ward and counterclockwise of the Northern and Southern hemispheres.

The mechanics of the Real Time Earth Clock are intricate and isometrically ensconced in the back base frame of the main housing. Each of the multi-interfaced axial drive shafts affixed to timing mechanisms provide the movement on the interrelating celestial components in relation to one other. The specific design for movement is predicated on the unique adroitness afforded by the engineering specifically in its plans offered by the engineer drawings.

### BRIEF DESCRIPTION OF THE DRAWINGS

FIG. 1 is a Top Plan view of the “Real Time Earth Clock” Has a frontal two dimension display of the earth sphere. The Earth manifests itself as the true depiction of itself with depictions of the earth's surface as rock formations along with a spherical ring showing the atomic expression of time in a counterclockwise rotation. While the rotation of the earth portrays time expression in correlation to the axial revolution, the earth globe moves the time dial as a true expression of atomic time represented by the 24 hour time table. The depiction here also designate the nuances of day light or night light specifically to the portion of the earth's geographical surface simulating the time sequence not only with the revolution sequence but in simultaneous movement with the time table display. While this portrait can be varied it is not construed to be the only variation of display or movement. The earth dial may remain stationary or may have the objective simulation to maneuver as it related to its time sequence and correlation to geographical depiction. Other variations of the inner displays can be sort as described throughout the provisional and patent details.

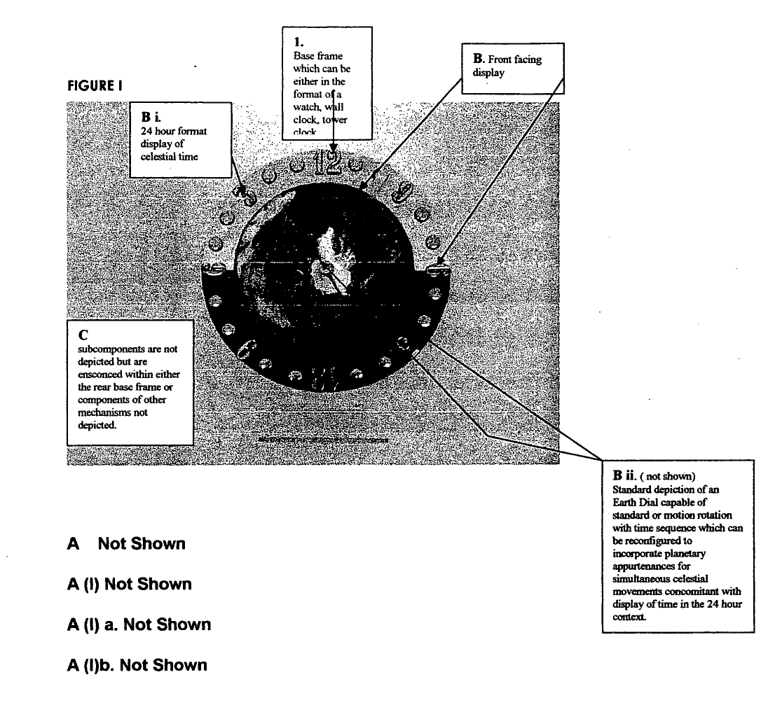

FIG. 2 is a Internal View of the Housing, sectional view of the Real Time Earth Clock, and Side Angle of the Base Frame for a three dimensional atomic movement. The diagram displayed shows the multi-interfaced drive shafts affixed to timing mechanisms for the movement of the celestial components—although many of the specific mechanisms are not shown; the engineering plans will have detailed specifications of such. A depiction of a darkened back drop utilizes opposing color or lights for daylight or nightlight. The base frame depicted would house the three dimensional celestial

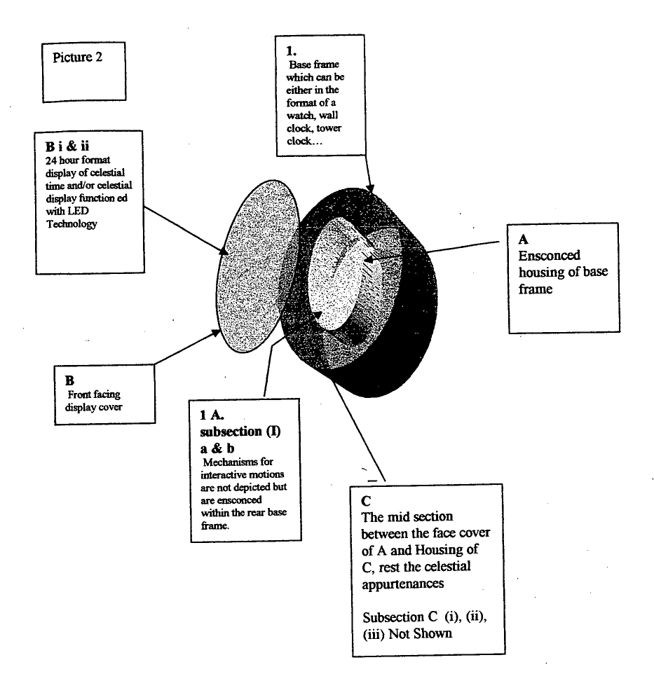

1.) A base frame containing the housing or clock components comprising of the following:
(1.1) an ensconced housing of the base frame containing:
(1.2) multi-interfaced axial drive shafts affixed to:
(1.3) timing mechanisms to facilitate the movement of the interrelating celestial components in relation to each other
(1.4) clandestine motion mechanisms for planetary and clock display movement

2.) exterior of base frame 1 encloses a front facing display having:
(2.1) numerical display of numerals or such others containing a 24 hour format;
(2.2). rotating earth dial in a clock ward motion whereas north pole centric will move in counter clockwise direction

3.) suspended planetary depictions of a taut sun & earth having a;
(3.1) north-south pole/axis with applicable devices for attachment and stationing purposes

4.) solidified back drop ensconcing the housing components including:
(4.1) translucent plastic covering enclosed with led or plasma components to emulate daylight/nightlight or
(4.2) dark background expressing in opposite tones or color of light
